(19) United States
(12) Patent Application Publication
(10) Pub. No.: US 2009/0190180 A1
(43) Pub. Date: Jul. 30, 2009

(54) METHOD AND APPARATUS FOR PRINTER CHARACTERIZATION

(75) Inventors: Francis Verbeeck, Berchem (BE); Marc Mahy, Wilsele (BE)

Correspondence Address: AGFA;c/o KEATING & BENNETT, LLP, 1800 Alexander Bell Drive, SUITE 200, Reston, VA, 20191, US

(73) Assignee: Agfa Graphics NV, Mortsel (BE)

(21) Appl. No.: 12/281,236

(22) PCT Filed: Feb. 27, 2007
(86) PCT No.: PCT/EP07/51827

§ 371 Date: Aug. 29, 2008

Related U.S. Application Data
(60) Provisional application No. 60/783,776, filed on Mar. 17, 2006.

(30) Foreign Application Priority Data
Mar. 1, 2006 (EP) 06110556.5

(51) Int. Cl. H04N 1/40

(52) U.S. Cl. 358/3.23

(57) ABSTRACT

A one dimensional transformation of colorant values before transforming them into a color using a printer model enables linearization of the gradation of each color component as a function of colorant values. The method reduces interpolation error if the printer model uses piecewise linear interpolation.

### CROSS-REFERENCE TO RELATED APPLICATIONS

This application is a 371 National Stage Application of PCT/EP2007/051827, filed Feb. 27, 2007. This application claims the benefit of U.S. Provisional Application No. 60/783,776, filed Mar. 17, 2006, which is incorporated by reference herein in its entirety. In addition, this application claims the benefit of European Application No. 06110556.5, filed Mar. 1, 2006, which is also incorporated by reference herein in its entirety.

### BACKGROUND OF THE INVENTION

1. Field of the Invention

The present invention relates to an image processing method for rendering color images on a printer. More specifically, the present invention relates to an improved mathematical printer model that relates color to colorant values for the printer.

2. Description of the Related Art

Color printing systems generally rely on subtractive color mixing of a set of colorants to render different colors. A set of colorants that is widely used includes cyan, magenta, yellow and black colorants.

A color separation process separates a color in a digital document into a set of colorant magnitudes that, when printed on top of each other, yield a faithful rendering of the color. A color separation process is usually based on inverting a mathematical printer model that expresses color as a function of printed colorant amounts.

The coefficients of a mathematical printer model are usually obtained by printing and measuring a printer target of which the colorant values are specified. By printing the target and measuring the colors of the patches, the relationship between colorant amount and the resulting color is known for the colorant combinations of the patches. A typical standard four colorant printer target includes colorant combinations having magnitudes of 0%, 10%, 20%, 40%, 70% and 100%.

The printer model uses an interpolation technique to predict the colors for other colorant combinations. For example, a tetrahedral interpolation technique can be used as disclosed in the article by Francis Schmitt and Jon Yngve Hardeberg, “Color Printer Characterization Using a Computational Geometry Approach”, Proceedings of IS&T and SID's 5th Color Imaging Conference, pages 96-99, Scottsdale, Ariz., November 1997.

Short and long term variations of a printer are managed by calibrating the printer. The aim of calibration is to bring a printer into a standardized condition, for example, corresponding to a reference printer.

A typical calibration method involves printing with each single colorant a stepped tone wedge and measuring the density of the patches. The density measurements are used to calculate a calibration curve that yields a desired relationship between the magnitude of a single colorant and the printed density.

One problem with the state of the art printer model is interpolation error.

Take, for example, a printer model that predicts the CIE L*a*b* color values as a function of cyan, magenta, yellow and black colorants between 0% and 100%. If the above tetrahedral interpolation is used, such a printer model will yield exact predictions for colorant combinations that occur in the printer target. For other colorant combinations, the model will predict the color as a weighted average of the colors of the vertices of a tetrahedron to which the colorant combination belongs.

For a single colorant, the tetrahedral interpolation degenerates to piecewise linear interpolation. FIG. 1 shows the CIE L* value 101 as a function of the magnitude 100 of a magenta colorant ranging from 0% to 100% as printed and measured (solid line 102) and as predicted by a piecewise linear model (dotted line 103). As FIG. 1 shows, the difference between the measured and the interpolated values is quite small for magnitudes of the magenta colorant between 0% and 70%, but it becomes slightly larger for the colorant magnitudes between 70% and 100%.

The document EP-A-1 083 739 teaches that the relationship between a colorant magnitude and at least one dimension of the resulting color is preferably substantially uniform on a psychovisual scale.

A first reason for this is that such an approach minimizes the visibility of quantization noise that results from quantitizing a colorant value with a limited number, say eight, bits.

A second advantage is that it results in a reduction of interpolation error.

Referring to FIG. 2, a printer has been calibrated in a calibration stage 201 so that the printed and measured CIE L* color component of a printed magenta colorant is a linear function of the colorant magnitude. Referring to FIG. 3, such a calibration technique results in zero interpolation error for the CIE L* value, since the measured (solid line) 302 and the piecewise linear interpolation (dotted line) 303 curves coincide.

The same, however, is not necessarily the case for the interpolation error of another color component. FIG. 4 shows the CIE b* value for magnitudes 401 of a magenta colorant ranging from 0% to 100% as printed and measured (solid line) 402 and as predicted by a piecewise linear model (dotted line) 403, whereby the printer was calibrated for linearity between the colorant magnitude and the CIE L* color component. Referring to FIG. 4, a substantial interpolation error 404 exists between the printed and measured CIE b* color component magnitude and the CIE b* color component as predicted by a piecewise linear interpolation printer model in the range between 70% and 100% colorant magnitude.

As the document EP-A-1 083 739 teaches, it may be advantageous for some colorants not to use the CIE L* for linearization purposes. A yellow colorant, for example, is advantageously calibrated by linearizing the CIE b* color component.

One solution available to a person skilled in the art to overcome the above problems is to reduce interpolation error by using a printer target that contains more patches. For example, one could use combinations of ten instead of six colorant values. While this method is very effective, it increases the number of patches that need to be printed and measured. This is undesirable, as it involves more time, more processing and more risk of mistakes that result in error. Furthermore, this approach involves using a non-standardized printer target.

Another solution available to a person skilled in the art includes using a non-linear interpolation technique, such as, for example, a cubic spline interpolation instead of the localized Neugebauer equations or the tetrahedral interpolation. While this solution is also effective, it is computationally more complex and more demanding than the aforementioned state of the art piecewise linear interpolation techniques.

### SUMMARY OF THE INVENTION

Accordingly, it follows that a need exists for an improved printer model that is computationally efficient, that uses a standardized printer target, and that minimizes interpolation error.

In order to overcome the problems described above and to satisfy this yet unmet need, preferred embodiments of the present invention provide an output device model split into partial output device models, whereby each partial output device model predicts one single color component as a function of colorant magnitudes. By applying a separate set of one-dimensional transformations of the colorant magnitudes for each partial output device model, the relationship between the colorant magnitudes and the color components can be made linear for all the color components.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 shows CIE L* color component in response to a magenta colorant magnitude ranging from 0% to 100% using no calibration.

FIG. 2 shows an output system including a calibration stage.

FIG. 3 shows CIE L* color component in response to a magenta colorant magnitude ranging from 0% to 100% using a prior art calibration method.

FIG. 4 shows CIE b* color component in response to a magenta colorant magnitude ranging from 0% to 100% using a prior art calibration method.

FIG. 5 shows an output system including hardware and software peripherals.

FIG. 6 shows a detail of an output system including a gradation calibration stage and a dynamic range mapping stage.

FIG. 7 shows an example of an output device target.

FIG. 8-A to FIG. 8-H support the explanation on tetrahedral interpolation in the text.

FIG. 9 shows an output device model for transforming a colorant vector having colorant components into a color having color components.

FIG. 10 shows a system according to a preferred embodiment of the present invention.

FIG. 11 shows the CIE b* gradation for magenta colorant magnitude variations between 70% and 100% and also a reference gradation.

FIG. 12 shows a one-dimensional transformation that linearizes the CIE b* response as a function of magenta colorant magnitude variations between 70% and 100%.

FIG. 13 shows how a preferred embodiment of the present invention reduces interpolation error in a system that uses piecewise linear interpolation.

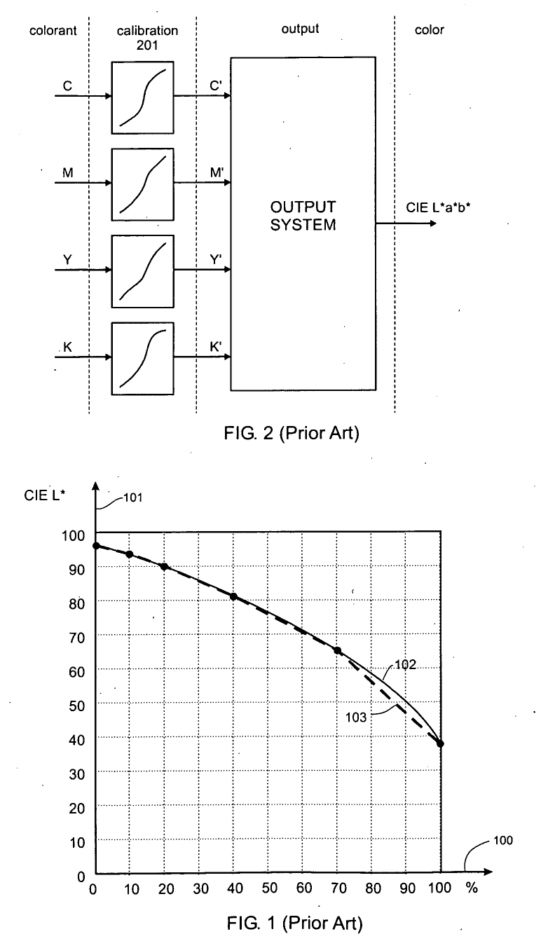

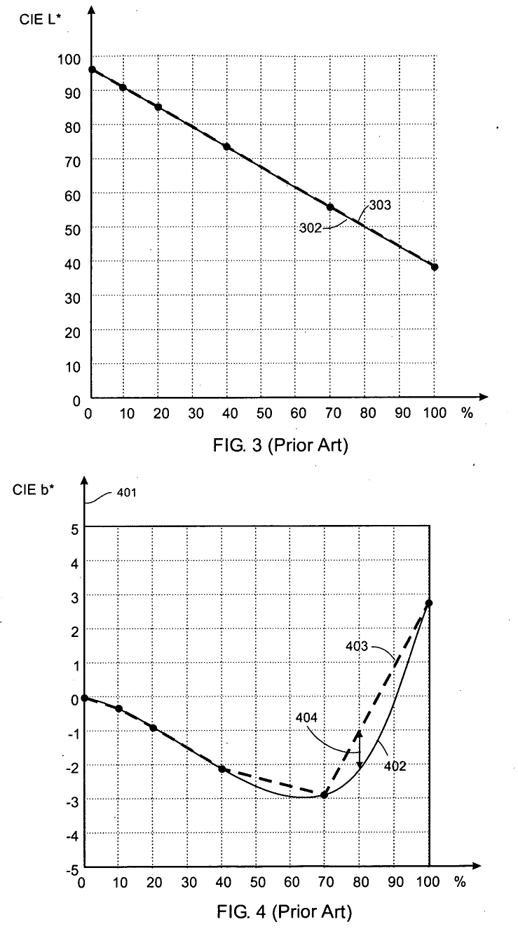

### DETAILED DESCRIPTION OF PREFERRED EMBODIMENTS

### Color and Color Space

The color of an object refers to the way the electromagnetic spectrum that it radiates is perceived by a human observer.

A color can be represented by a color vector including components of which the magnitudes correspond with the energy magnitudes of a set of primary colors that, when additively mixed, yield visually the same impression to the observer as the color.

It has been demonstrated that a vector having three components is sufficient to represent a color in a unique way to a standard observer. In that case, the color space is three-dimensional.

The three components can correspond to a set of three real primaries, such as a red, green and blue primary, or a set of three virtual primaries such as the CIE XYZ primaries. A characteristic of the CIE XYZ set of primaries is that they correspond with the integrated responses as measured through a set of three spectral filters that are linear combinations of the receptor responses of the human visual system of a standard observer.

Another approach uses a transformation of the coordinates in the CIE XYZ primary system to yield a locally psychovisually uniform color space. The preferred embodiments of the present invention will mainly deal with the locally psychovisually uniform color space CIE L*a*b* to represent colors, although other color spaces can also be used for the preferred embodiments of the present invention.

More information on the subject of color spaces is found in the publication “Color Science: Concepts and Methods, Quantitative Data and Formulae” (2nd ed.) by G. Wyszecki & W. S. Stiles, published in 1982 Wiley (N.Y.), pp. 164-168.

Color appearance models are designed to take into effect the observation that the psychovisual appearance of a color stimulus may be affected by the presence of other visual stimuli. An example of such a color appearance model is the CIECAM02 color space, which expresses colors in terms of three dimensions having a semantic interpretation such as lightness, hue and saturation.

Color spaces are also referred to as device independent spaces.

### Colorant, Substrate, and Colorant Space

A colorant means a substance that induces a color or modifies the hue of something else by absorbing, reflecting or emitting visible light. The absorption, reflection or emission can be spectrally flat, or it can be spectrally selective.

A colorant can be a conventional pigmented or dyed ink or colorant, but it can also be wax, a water repellent substance, an adhesive or a plastic. Usually a colorant is not a pure compound, but a complex mixture including several components such as dyes, pigments, surfactants, binders, fillers, solvents, water and dispersants, each component serving a specific function. The colorant could also be a material of which the viscosity or phase changes with temperature, such as a wax. Specifically mentioned also are colorants that polymerize, for example, under the influence of electromagnetic radiation such as UV light. This process is called curing.

A colorant magnitude represents an amount of light absorption, reflection or emission. A colorant magnitude can be represented on a scale from 0% to 100%, for example, to represent a magnitude of the colorant that ranges from minimum absorption on a substrate to maximum absorption. A colorant magnitude can also be represented using an eight bit word on a scale from 0 to 255, for example, corresponding with a range from minimum to maximum emission in the case of a display system. Other possibilities also exist, e.g., colorant magnitudes represented on a 1 bit, a 12 bit or a 16 bit scale.

In the preferred embodiments of the present invention, colorants having the same hue mean that they share the same primary absorption peak as measured by a graphic arts densitometer, such as, for example, the X-Rite model 530.

In the case of neutral colorants, colorants having the same hue mean colorants that have a CIE a* and CIE b* value of which:

(CIE a*)*(CIE a*)+(CIE b*)*(CIE b*)<16

when the colorants are separately printed on a substrate using the print levels that produce the maximum density on the substrate.

Colorants having the same hue can have the same densities, but preferably have different densities. For example, a first cyan colorant can have a density that is lower than the density of a second cyan colorant.

A colorant vector is a vector of which the components are colorant magnitudes. A colorant vector can be represented in a colorant space of which the dimensions correspond with the colorant magnitudes.

A substrate could be paper, but it could also be textile, a synthetic foil or a metal plate on which colorant is laid down by an output device.

### Pixel and Image

A pixel is a two-dimensional spatial unit to which a color or colorant vector is associated.

An image is a spatial two-dimensional arrangement of pixels. Within the scope of the preferred embodiments of the present invention, an image also includes a sequence of temporally related images, for example, for rendering motion pictures or television images. Also included are compressed images, i.e., images on which signal processing techniques have been applied to reduce pixel and coding redundancies.

### Output Device

An output device means a hardware device that is capable to render images. In the preferred embodiments of the present invention, rendering and printing both refer to the process of rendering an image on an output device, whatever its nature. In the preferred embodiments of the present invention, the rendering of color by an output device or system will be referred to as a rendering process, or, in short, a process.

Output devices include display and printing devices. Examples of display devices include CRTs, LCDs, plasma and projection displays. Most of these devices can render both static and motion pictures. Examples of printing technologies include printers for photographic paper, electro-photographic printers, thermal transfer printers, dye sublimation printers, ink jet printers, offset printers, gravure printers and flexographic printers.

An output device can be monochrome or color, depending on its capabilities to render monochrome or color images. A device that is capable to independently vary for each pixel the magnitude of n distinct colorants is to have an n-dimensional colorant space, wherein each dimension corresponds with one of the colorants. Such a device is capable to print a pixel having an n-dimensional colorant vector.

Take, for example, an offset printing press. Most offset presses are operated using cyan (C), magenta (M), yellow (Y) and black (K) inking stations. The number of colorants and, hence, the dimensionality of the colorant space is four.

The colorant space that is associated with an output device is sometimes referred to as a device dependent colorant space, wherein the device refers to the output device.

The colorant gamut of an output device corresponds with all possible combinations of colorant magnitudes that the output device is capable to render.

In the absence of any limitations on colorant combinations, the colorant gamut associated with a process having an n-dimensional color space is an n-dimensional cube. In most practical situations not all possible colorant combinations are acceptable for rendering. Such a limitation on combining different colorant magnitudes reduces the colorant gamut.

### Output System

An output system is a system that includes an output device, but typically also software and hardware peripherals to operate the device, such as printer drivers, color correction and digital halftoning software and the systems they run on.

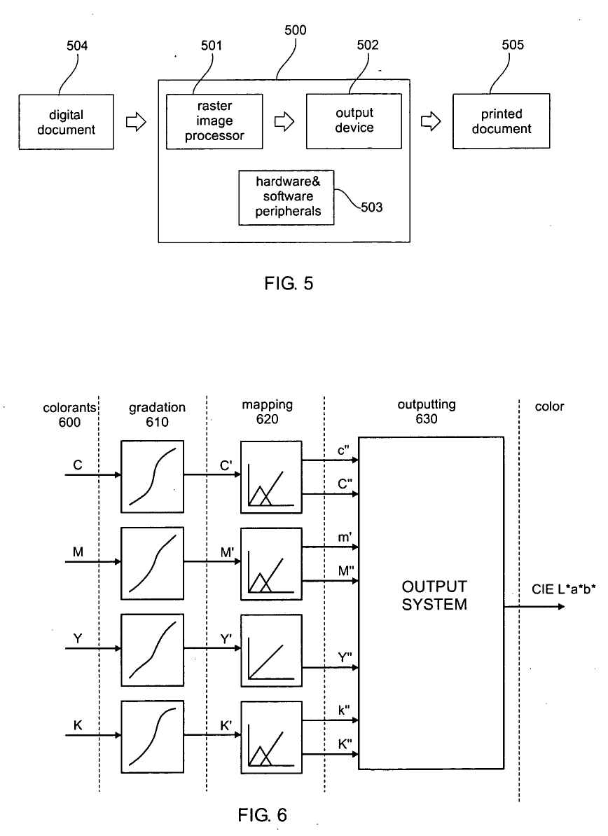

FIG. 5 shows a system according to a preferred embodiment of the present invention. The input for the system 500 is a digital document 504 that is to be converted into a printed document 505.

Usually this document 504 is represented in a device independent format such as, for example, TIFF, PDF®, MS-Word®, or PostScript®.

The system includes a raster image processor 501 to transform the digital document 504 into a raster image having a spatial and tonal resolution and a colorant space.

According to a preferred embodiment, the raster image processor uses a computer program such as, for example, “Adobe PostScript Printer Driver” commercialized by the company Adobe Systems Incorporated, located in San Jose Calif. The raster image processor also includes a color management system to separate a color vector of an object in a digital input document into a colorant vector represented in the colorant space.

The data from the raster image processor is sent to an output device 502 for producing the printed document 505.

The raster image processor 501 and the output device 502 are supported by peripheral hardware and software 503. The raster image processor program preferably runs on a data processing system. The output device 502 includes an output device controller to manage the functions of the device.

Referring to FIG. 6, a colorant channel refers to the image processing and rendering chain that is related to one single colorant.

In the system shown in FIG. 6, the conversion of a set of colorant 600 magnitudes (C,M,Y,K) involves preferably first a gradation calibration stage 610 to obtain gradation corrected colorant magnitudes (C′,M′,Y′,K′), followed by a mapping stage 620 to obtain mapped colorant magnitudes (c″, C″,m″,M″,Y″,k″,K″), followed by an outputting stage 630 to obtain a rendered image. The purpose of the mapping stage is to split, for example, a global cyan colorant magnitude C′ into a combination of a first partial cyan colorant magnitude c″, and a second partial cyan colorant magnitude C″, wherein c″ C″ are colorants having substantially the same hue but different densities.

### Output Device Target

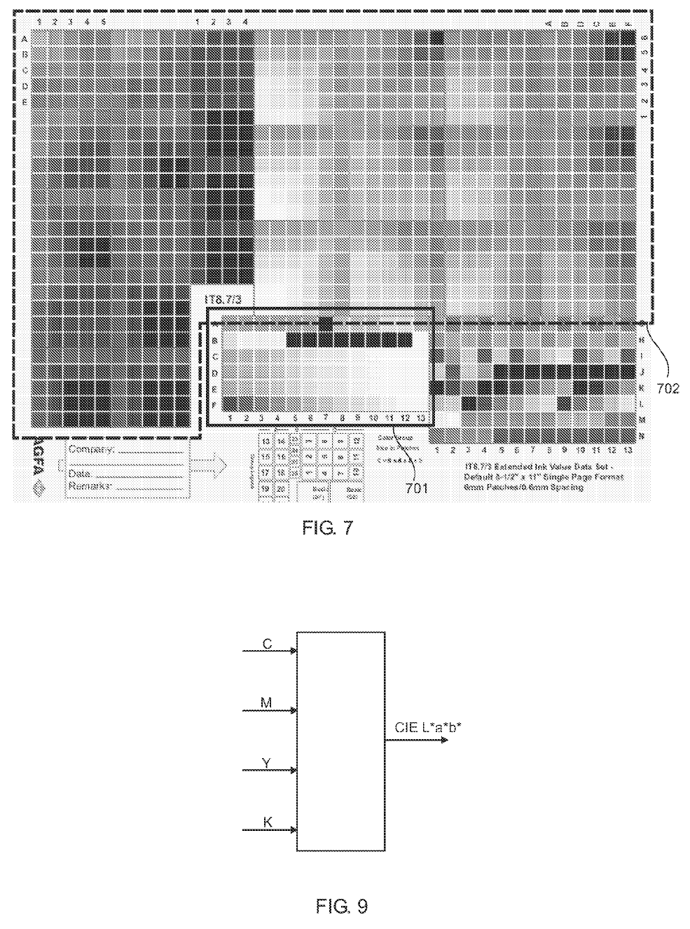

An example of an output device target is the IS12642 target (formerly called ANSI IT 8.7/3) shown in FIG. 7. This target contains a subset 702 of combinations of six cyan, magenta, yellow and black colorant magnitudes (0%, 10%, 20%, 40%, 70% and 100%).

Preferably the patches of an output device target are combinations of a set of sampling points along the different dimensions in colorant space. By making all the possible combinations of the sampling points, an ordered grid of points in colorant space is defined. In the remaining preferred embodiments of the present invention, they are referred to as the “grid points”.

The output device target in FIG. 7 also includes step wedges 701 of the pure colorants having colorant magnitudes (0%, 3%, 7%, 10%, 15%, 20%, 25% 30%, 40%, 50%, 60%, 70%, 80%, 90% and 100%). These step wedges are commonly used to calibrate an output system. Preferably, the step wedges 701 have a finer granularity on the colorant magnitude scale than the sampling of colorant magnitudes for the subset 702 in the output device target.

The output device target is measured, preferably using a calorimeter, such the X-Rite 962 0°/45° Portable Spectrophotometer. Other measurement devices are specifically mentioned, including an automatic measurement table and a data processing system to manage such a table and acquiring, storing and processing the measurement data. If no spectrophotometer is available, a color densitometer can also be used, but this solution is not preferable.

In a preferred embodiment, an output device target includes all the points of the ordered grid. In the preferred embodiments of the present invention, such an output device target is referred to as “complete”. In another preferred embodiment, an output device target includes only a subset of points of the ordered grid. In the preferred embodiments of the present invention, such a target is referred to as “incomplete”. The document EP-A-1 146 726 teaches that it is possible to print and measure an incomplete output device target and to use the color vectors of the grid points of the incomplete output device target to derive color vectors for grid points that belong to a complete output device target.

### Calibration of an Output System

In the preferred embodiments of the present invention, a gradation means any scalar entity, physical or virtual, that varies in response to a colorant variation. Typically, the scalar entity is a density (measured through a neutral filter or a red, green or blue filter) or a color component such the CIE L* component or a CIE a* or CIE b* component. The entity can also be a colorant magnitude itself, for example, it can be a corrected or transformed colorant magnitude.

According to a preferred embodiment of the present invention, an output device target is preferably first calibrated before an output device target is printed. Calibration involves normalizing for each colorant separately the relationship between the magnitude of the colorant and the resulting color to a predefined reference gradation, which is, for example, the gradation of a reference printer.

For example, an output device can be calibrated so that the printed density of the colorant as measured with a graphic arts scanner such as the X-Rite 938 varies proportionally with the magnitude of the colorant. Alternatively the calibration can be such that the density varies according to a predefined curve.

Referring to FIG. 6, the calibration of an output device is preferably obtained by transforming a first colorant magnitude (C, M, Y, K) into a second colorant magnitude (C′, M′, Y′, K′) so that when the second global colorant magnitude is output, it results in the desired density. The transformation can be implemented in a separate look-up-table step prior to digital halftoning and printing or it can preferably be combined with the mapping curves and be incorporated in the digital halftoning step itself as explained in EP-B-0639 023 to reduce the loss quantization levels.

The document EP-A-1 083 739 teaches that a calibration step preferably results in a linear relationship between the colorant magnitude and a psychovisually uniform dimension of the resulting color, such as, for example, the CIE L* component. As the document explains, this approach minimizes the visual quantization noise that results from quantizing a colorant magnitude with a limited number of, say eight, bits.

### Output Device Model and Interpolation

An output device model is a mathematical function that expresses what color vector results from printing a colorant vector on an output system.

According to a preferred embodiment of the present invention, an output device model is preferably a continuous function.

An n-dimensional rendering process is characterized if:
its output device model is defined; and
its colorant gamut is defined (specifically including colorant limitations).

The coefficients of an output device model are preferably determined using an output device target. By printing the target, and measuring the color of the patches, a relationship between colorant vectors and the resulting color vectors can be determined.

According to a preferred embodiment of the present invention, a printer model uses an interpolation technique to predict a color vector as a function of a colorant vector for colorant vectors that are not part of the ordered grid of points in colorant space.

A first example of an interpolation technique uses interpolating polynomials to express color component magnitudes as a function of colorant component magnitudes. The coefficients of such a polynomial are, for example, determined by minimizing the deviation between the measured and predicted responses for the grid using a linear regression technique.

A second example of an interpolation technique are the “localized Neugebauer equations” as explained in the article by Marc Mahy and Paul Delabastita, “Inversion of the Neugebauer Equations,” Color Research and Application, Vol. 21, No 6, pp. 404-411.

A third example of a preferred interpolation technique is a tetrahedral interpolation technique as explained in the article by Francis Schmitt and Jon Yngve Hardeberg, “Color Printer Characterization Using a Computational Geometry Approach”, Proceedings of IS&T and SID's 5th Color Imaging Conference, pages 96-99, Scottsdale, Ariz., November 1997.

The second and third interpolation techniques are based on:
subdividing the n-dimensional colorant space into a contiguous set of n-dimensional polyhedrons of which the vertices correspond to grid points;
determining to which polyhedron a given colorant vector belongs; and
using linear interpolation between the color vectors corresponding to vertices of the polyhedron to predict a color vector corresponding to the colorant vector.

In the case of the Neugebauer equations, the polyhedrons are n-dimensional hypercubes; in the case of the tetrahedral interpolation, the polyhedrons are n-dimensional simplexes.

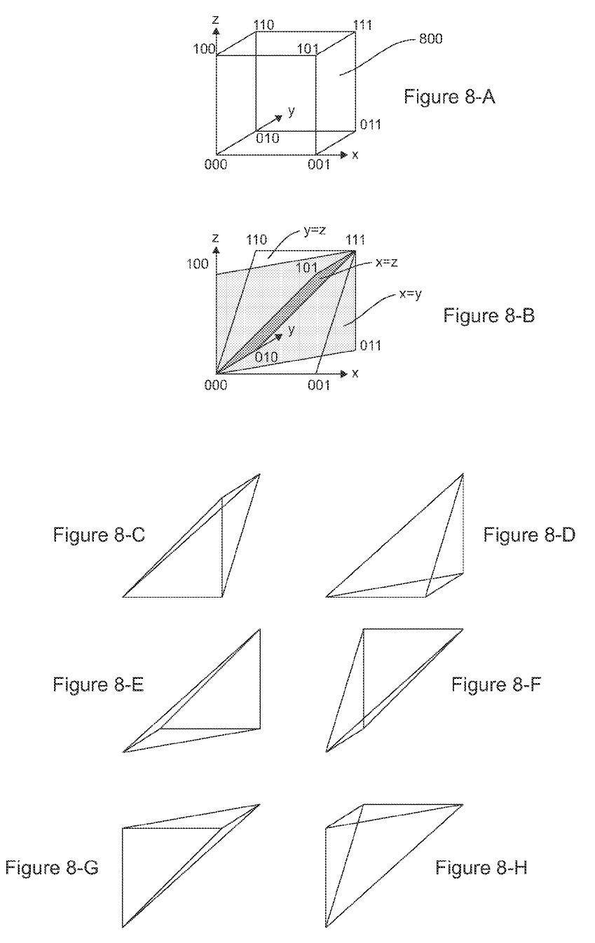

FIG. 8-A gives an example of a tetrahedral interpolation technique for a system having x, y and z colorants. The vertices 000, 001, 010, 011, 100, 101, 110 and 111 define a parallelepiped in a three colorant space. Each vertex corresponds with a colorant vector of which the color is known, for example, based on the measurements of an output device target.

Referring to FIG. 8-B, the three planes x=y, y=z and x=z are diagonal planes. Each plane divides the colorant space into two half-spaces. Together these three planes divide the three-dimensional colorant cube 800 into 6 tetrahedron subspaces FIG. 8-C to FIG. 8-H. Each tetrahedron is a three-dimensional simplex having four vertices. Tetrahedral interpolation for a colorant vector involves:
1) determining for a colorant in the three-dimensional colorant space to which tetrahedron subspace it belongs by determining for each of the planes x=y, x=z and x=z to which subspace the colorant vector belongs; and
2) linearly interpolating between the colors c(v1), c(v2), c(v3) and c(v4) of the vertices v1, v2, v3 and v4 of the tetrahedron.

The two above interpolation techniques (Neugebauer and tetrahedron) share the property that they predict a color vector exactly for colorant vectors that correspond with grid points of the printer target and that they degenerate into piecewise linear interpolation between the sampling points of the target along the colorant dimensions of the colorant space. The tetrahedral interpolation has an additional property that it degenerates into piecewise linear interpolation between the sampling points of the target along the diagonals of the ordered grid in colorant space. Mathematical Description of a Tetrahedral Interpolation for a 3-Colorant Process

Let a finite set {wᵢ}⊂W² of points wᵢ, i=1, . . . , N, inside the colorants cube W³ be a regular mesh. Consider a discrete map f: {wᵢ}→{pᵢ} of measurement data, where pᵢ=f(wᵢ)=F(wᵢ) for i=1, . . . , N.

To approximate the given discrete map f by a continuous map F: W³→R³, piecewise linear interpolation is used.

By definition of a regular mesh, for k=1, 2, 3 there exists the one-dimensional meshes Z^{k}={x^{k}₀, . . . , x^{k}_{N(k)}}, with a^{k}=x^{k}₀< . . . <x^{k}_{N(k)},=b^{k}, of N(k)+1 real numbers such that {wᵢ}=Z¹×Z²×Z³⊂W³ and N=(N(1)+1)(N(2)+1)(N(3)+1).

This means that the three-dimensional colorants cube W³ can be decomposed into the union

$${W}^{3} = ⋃ i = 1 , … , N ( 1 ) . j = 1 , … , N ( 2 ) . k = 1 , … , N ( 3 ) {\prod }_{i , j , k}$$

of the mesh parallelepiped cells Π_{i,j,k}=[x¹ᵢ₋₁, x¹ᵢ]×[x²ⱼ₋₁, x²ⱼ]×[x³ₖ₋₁, x³ₖ], i=1, . . . , N(1), j=1, . . . , N(2), k=1, . . . , N(3). Inside each of these parallelepiped cells the continuous approximation F of the measurement discrete map f is constructed in the following way.

Consider an arbitrary three-dimensional rectangular parallelepiped Π=[a¹, b¹]×[a², b²]×[a³, b³]={(x¹,x²,x³), a¹≦x¹≦b¹, a²≦x²≦b², a³≦x³≦b³}, where a¹, b¹, a², b², a², and b³ are fixed real numbers. There is an obvious one-to-one correspondence of the 8 vertices to the rectangular parallelepiped Π and the 8 vertices (0,0,0), (0,0,1), (0,1,0), (0,1,1), (1,0,0), (1,0,1), (1,1,0), (1,1,1) to the unit three-dimensional cube Π₁={(x¹,x²,x³) 0≦x¹≦1, 0≦x²≦1, 0≦x³≦1}.

Numerate all the 8 vertices of the rectangular parallelepiped Π by means of the corresponding vertices of the unit cube Π₁, x₀₀₀, x₀₀₁, x₀₁₀, x₀₁₁, x₁₀₀, x₁₀₁, x₁₁₀, x₁₁₁.

Apply the same numeration to the values of the discrete map f, i.e., put pᵢⱼₗ=f(xᵢⱼₗ) for i,j,l=0, 1.

Define the map F inside the rectangular parallelepiped Π, yⁿ=Fⁿ(x¹,x²,x³)=pⁿ₀₀₀+rⁿ₁Δx¹+rⁿ₂αx²+rⁿ₃Δx³, where n, n=1, 2, 3, is the number of component of the map F in three-dimensional color space R³ and Δxⁱ=(xⁱ−xⁱ₀)/(xⁱ₁−xⁱ₀) for i=1, 2, 3. The coefficients rⁿᵢ, i=1, 2, 3, are determined in correspondence with the following table

| No | Conditions | rⁿ₁ | rⁿ₂ | rⁿ₃ |
|---|---|---|---|---|
| 1 | Δ x¹ ≧ Δ x² ≧ Δ x³ | pⁿ₁₀₀-pⁿ₀₀₀ | pⁿ₁₁₀-pⁿ₁₀₀ | pⁿ₁₁₁-pⁿ₁₁₀ |
| 2 | Δ x¹ ≧ Δ x³ ≧ Δ x² | pⁿ₁₀₀-pⁿ₀₀₀ | pⁿ₁₁₁-pⁿ₁₀₁ | pⁿ₁₀₁-pⁿ₁₀₀ |
| 3 | Δ x³ ≧ Δ x¹ ≧ Δ x² | pⁿ₁₀₁-pⁿ₀₀₁ | pⁿ₁₁₁-pⁿ₁₀₁ | pⁿ₀₀₁-pⁿ₀₀₀ |
| 4 | Δ x² ≧ Δ x¹ ≧ Δ x³ | pⁿ₁₁₀-pⁿ₀₁₀ | pⁿ₀₁₀-pⁿ₀₀₀ | pⁿ₁₁₁-pⁿ₁₁₀ |
| 5 | Δ x² ≧ Δ x³ ≧ Δ x¹ | pⁿ₁₁₁-pⁿ₀₁₁ | pⁿ₀₁₀-pⁿ₀₀₀ | pⁿ₀₁₁-pⁿ₀₁₀ |
| 6 | Δ x³ ≧ Δ x² ≧ Δ x¹ | pⁿ₁₁₁-pⁿ₀₁₁ | pⁿ₀₁₁-pⁿ₀₀₁ | pⁿ₀₀₁-pⁿ₀₀₀ |

The interpolation under consideration has a pure geometrical sense. We decompose a three-dimensional rectangular parallelepiped into six tetrahedrons. These tetrahedrons are defined by the conditions in the second column of the table above. Inside each tetrahedron, the map F is constructed by linear interpolation of the values pᵢⱼₗ, i,j,l=0, 1, of the discrete map f at the vertices to the tetrahedrons.

While this mathematical description has been given for the case of a three-colorant process, it is easily extended by the person skilled in the art for a process having any number of colorants.

### Device Model Inversion

An output device model enables to predict in what color vector the rendering of a colorant vector results. In the preferred embodiments of the present invention, model inversion refers to the process of inverting an output device model so that colorant vectors can be predicted that, when rendered, yield a given preset color vector. The principles of inverting an output device model based are explained in the previously cited documents on this subject.

### Forward and Inverse Look-Up Tables

A color image can include millions of pixels. For converting between the color and colorant vectors of these pixels, preferably a look-up table in combination with an efficient interpolation algorithm is used, because this approach is computationally more efficient that an evaluation pixel-by-pixel of an output device model and/or model inversion.

In the preferred embodiments of the present invention, a forward look-up table includes colorant vectors as the entries and color vectors as data points. A forward look-up table is populated by evaluating an output device model for its entries.

Similarly, an inverse look-up table includes color vectors as the entries and colorant vectors as data points. An inverse look-up table is populated by evaluating the inverse output device model.

In the preferred embodiments of the present invention, forward look-up tables are also referred to as color tables, whereas inverse look-up tables are also referred to as color separation tables.

### PREFERRED EMBODIMENTS

A preferred method according to the present invention includes the following steps.

In a first step, an output device is optionally calibrated. The calibration is preferably achieved by linearizing for each colorant either the CIE L* value, or the CIE a* value or CIE b* value as a function of the colorant magnitude using one of the prior art techniques that were previously mentioned. For a cyan, magenta or black colorant, the calibration preferably linearizes the CIE L* gradation. For a yellow or orange colorant, the calibration preferably linearizes the CIE b* gradation.

In a next step, an output device target, such as that shown in FIG. 7 including a first set of patches 701 and a second set of patches 702, is printed with the optionally calibrated output device and the at least two color components of the patches of the target are measured. Preferably, the printer target includes combinations of a first set of colorant magnitudes forming an ordered grid of colorant vectors in colorant space.

The measured data of the second set 702 of patches can be used to determine the coefficients of an output device model. The output device model preferably uses piecewise linear interpolation as, for example, in the localized Neugebauer equations or on tetrahedral interpolation that were previously mentioned.

Referring to FIG. 9, an output device model transforms a colorant vector having, for example, CMYK components into a color vector having, for example, CIE L*a*b* color components. According to a preferred embodiment of the present invention, the color vector includes at least two and preferably three color components.

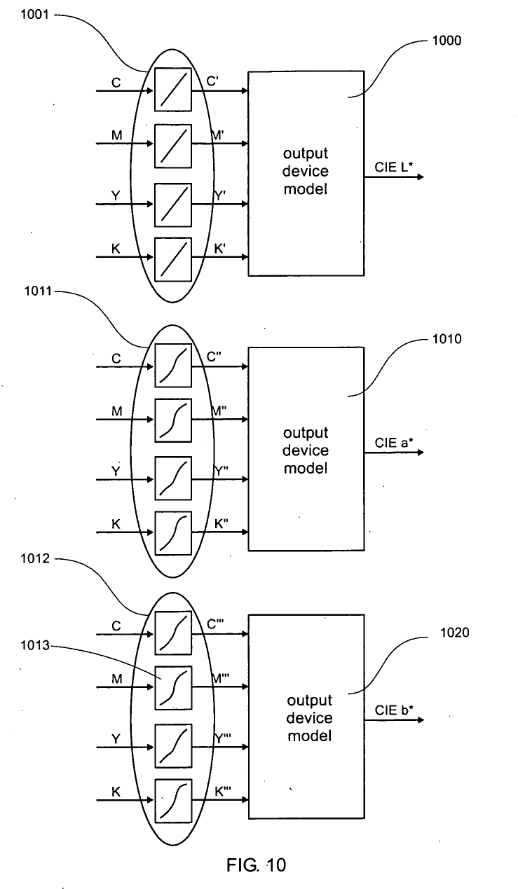

Referring to FIG. 10, an output device model can be broken up into at least three partial output device models 1000, 1010 and 1020, whereby each partial output device model transforms the components of a colorant vector into one component of a color vector. According to a preferred embodiment of the present invention, before the colorant components are transformed into a color component, they are transformed by sets of one-dimensional transformations 1001, 1011 and 1012, whereby each set of one-dimensional transformations corresponds with a partial output device model.

According to a preferred embodiment of the present invention, the one-dimensional sets of transformations 1001, 1011 and 1012 are selected so that the gradation of a color component as a function of a colorant is piecewise linear for each of the partial output device models.

In the preferred embodiments of the present invention, a piecewise linear gradation includes variations of up to 5% of the dynamic range of the entity that changes in response to a colorant magnitude variation.

Also, piecewise linearity in the preferred embodiments of the present invention is preferably considered for a color component variation in response to a variation of a single colorant. For example, if a CIE b* color component varies piecewise linearly as a function of a magenta colorant magnitude, it is assumed that other colorants that are part of the same output process, for example, cyan, yellow and black colorants have fixed, preferably zero, magnitudes.

Also, piecewise linearity preferably refers to linearity between the grid points of an output device target. For example, referring to the colorant grid 702 in FIG. 7, piecewise linearity preferably means linearity in the intervals [0%, 10%], [10%, 20%], [20%, 40%], [40%, 70%] and [70%, 100%].

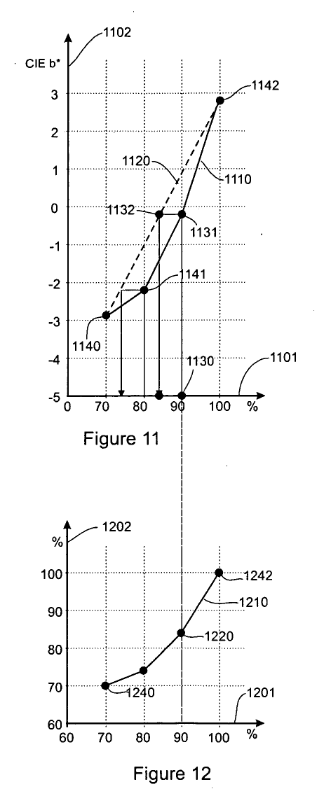

One method to select a one-dimensional transformation according to a preferred embodiment of the present invention is explained by FIG. 11 to FIG. 13 that serve as an example that can be generalized by a person skilled in the art.

In FIG. 11, the curve 1110 indicates the measured CIE b* color component as a function of a specified magenta colorant magnitude in a range from 70% to 100%.

The measurements 1140 and 1142 correspond to magenta colorant magnitudes that are specified in the set 702 (FIG. 7) of an output device target. They are grid points of the printer model and act as vertices of a polyhedron for the purpose of interpolation.

The measurements 1141 and 1131 correspond to magenta colorant magnitudes that are specified in the set 701 (FIG. 7) corresponding to a step wedge of an output device target.

The curve 1120 indicates a reference curve. According to a preferred embodiment of the present invention, the reference curve is preferably locally linear between the grid points 1140 and 1142.

Referring to FIG. 12, the curve 1210 maps an untransformed magenta colorant magnitude 1201 onto a transformed magenta colorant magnitude 1202 using a one-dimensional transformation.

A point 1220 of the one-dimensional transformation 1210 is obtained by:
mapping the abscissa 1130 corresponding to a point 1220 of the transformation parallel to the ordinate axis 1102 onto the measured response curve to obtain a measured color component 1131;
mapping the measured color component 1131 parallel to the abscissa axis 1101 onto the reference curve 1120 to obtain a reference response 1132; and
mapping the reference response parallel to the ordinate axis 1102 onto the abscissa axis 1101 to obtain a ordinate value for a point 1220 of the one-dimensional transformation.

By repeating the above procedure for all the colorant magnitudes of the set 701 (FIG. 7) between the points 1140 and 1142, a one dimensional transformation curve 1210 is obtained between the points 1240 and 1242.

Referring to FIG. 10, the one-dimensional transformation curve 1210 can be used in a transformation stage 1013.

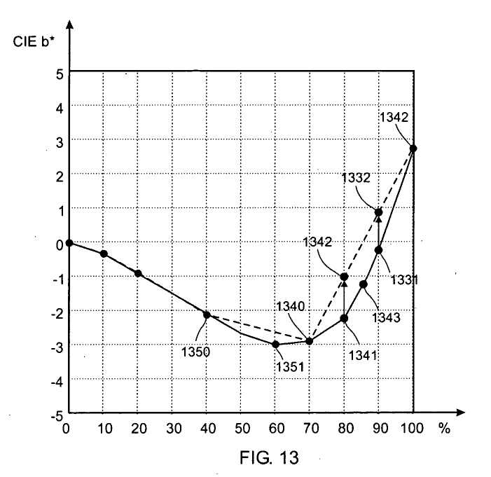

Referring to FIG. 13, the effect of the calibration is that for colorant magnitudes between 70% and 100%, the original measured CIE b* components 1341 and 1331 are mapped onto the transformed CIE b* magnitudes 1342 and 1332. Since these magnitudes fall on a straight line segment between the CIE b* magnitudes 1340 and 1342, interpolation error from piecewise linear interpolation between the CIE b* magnitudes 1340 and 1342 for varying magenta colorant magnitudes is greatly reduced.

Referring to FIG. 13, the same principles can be used to reduce the interpolation error of the CIE b* color component for variations of the magenta colorant between 0% and 10%, between 10% and 20%, between 20% and 40% and between 40% and 70%. In short, the interpolation error of the CIE b* color component for variations of the magenta colorant can be reduced over its complete range from 0% to 100%.

The method that was just explained requires that within a piecewise interpolation interval between the grid points 1140 and 1142 (FIG. 11) the measured color component response curve 1110 is monotonous. If this condition is not met, the step of mapping a measured color component onto a reference color component does not yield a unique result and the method breaks up. Such a situation occurs, for example, between the grid points 1350 and 1340 in FIG. 13. In that case, one or more measured color component responses can be omitted to restore monotonousness. For example, by omitting the measured point 1351 the measured color component response curve between the points 1350 and 1340 becomes monotonous again.

According to a preferred embodiment of the present invention, piecewise linearity is only evaluated for colorant vectors that have been included for processing in the method for obtaining a one dimensional transformation.

Referring to FIG. 13, for example, piecewise linearity is only evaluated for the points 1340, 1341, 1331, 1342, but not for the point 1343, as the latter point was not included for processing in the method according to a preferred embodiment of the present invention. Similarly, piecewise linearity is not evaluated for the point 1351, as this point was also not included for processing.

The method that was just explained for reducing the interpolation error of a CIE b* color component can just as well be used to reduce the interpolation error of the CIE L* and CIE a* color components for variations of the magenta colorant over its range from 0% to 100%.

Similarly, the same principles can be used to reduce the interpolation error of the CIE L*a*b* color components for variations of the other colorants.

In general, an output device model that transforms n (n>=1) colorants into m (m>=2) color components includes n*m one-dimensional transformations so that any of the m color components varies a linear function of any of the m colorants.

The method according to a preferred embodiment of the present invention is preferably carried out on a data processing system such as a computer. A computer preferably includes a network connection, a central processing unit and a memory which are all connected through a computer bus. The computer typically also has a computer human interface for inputting data and a computer human interface for outputting data. According to a preferred embodiment, the computer program code is stored on a computer readable medium such as a mass storage device or a portable data carrier which is read by a portable data carrier reader.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-11. (canceled)

12: A method for transforming a colorant vector for driving an output device having at least one colorant component into a color vector having at least two color components, the method including:
applying one-dimensional transformations on the at least one colorant component to obtain transformed colorant components; and
using an output device model of the output device for transforming the transformed colorant components into color components; wherein
the one-dimensional transformations are selected so that each color component varies piecewise linearly as a function of the colorant component.

13: A method according to claim 12, wherein the output device model includes a look-up table including grid points corresponding to an output device target of the output device, and an interpolator.

14: A method according to claim 12, further including a model inversion step.

15: A method according to claim 13, further including a model inversion step.

16: A method according to claim 14, further including a printing step.

17: A method according to claim 15, further including a printing step.

18: A system for transforming a set of m (m>=1) colorant components for driving an output device into a set of n (n>=2) color components, the system including:
n sets of m one-dimensional transformations arranged to transform the colorant components into transformed colorant components; and
an output device model of the output device arranged to transform the n sets of m transformed colorant components into n color components; wherein
the n sets of m one-dimensional transformations are selected so that the n color components vary piecewise linearly in response to variations of the m colorant components.

19: A system according to claim 18, wherein the output device model includes grid points corresponding to an output device target of the output device, and a m-dimensional interpolator.

20: A system according to claim 18, further including an inverter arranged to invert the output device model.

21: A system according to claim 19, further including an inverter arranged to invert the output device model.

22: A system according to claim 20, further including the output device.

23: A system according to claim 21, further including the output device.

24: A data processing system that is programmed by computer code instructions arranged to transform a set of m (m>=1) colorant components for driving an output device into a set of n (n>=2) color components, the system including:
means for one-dimensional transforming n sets of m colorant components into transformed colorant components;
means for m-dimensional transforming the n sets of m transformed colorant components into n color components; wherein
the means for the one-dimensional transforming transform the n sets of m color components to that the n color components vary piecewise linearly in response to variations of the m colorant components.

25: A computer readable medium storing computer code instructions suitable for running on a data processing system for transforming a set of m (m>=1) colorant components for driving an output device into a set of n (n>=2) color components, the system including:
means for one-dimensional transforming n sets of m colorant components into transformed colorant components;
means for m-dimensional transforming the n sets of m transformed colorant components into n color components; wherein
the means for the one-dimensional transforming transform the n sets of m color components to that the n color components vary piecewise linearly in response to variations of the m colorant components.
